(19) United States
(12) Patent Application Publication
(10) Pub. No.: US 2005/0265225 A1
(43) Pub. Date: Dec. 1, 2005

(54) MIMO system and mode table

(75) Inventors: Ravishankar H. Mahadevappa, Irvine, CA (US); Stephan ten Brink, Irvine, CA (US)

Correspondence Address: CHRISTIE, PARKER & HALE, LLP, PO BOX 7068, PASADENA, CA, 91109-7068, US

(73) Assignee: Orion Microelectronics Corporation

(21) Appl. No.: 11/127,029

(22) Filed: May 10, 2005

Related U.S. Application Data
(60) Provisional application No. 60/570,369, filed on May 11, 2004.

(51) Int. Cl. H04J 11/00

(52) U.S. Cl. 370/210

(57) ABSTRACT

A method for determining antenna usage in a multiple input multiple output (MIMO) wireless communication system. The method includes exchanging information between terminals concerning the number of transmit antennas and number of receive antennas. In some embodiments antenna usage is based on the number of transmit antennas, the number of receive antennas, and an indication of channel quality. In some embodiments less than all of the available antennas, particularly transmit antennas, are used at a given time, with unused transmit antennas varying over time.

### CROSS-REFERENCE TO RELATED APPLICATION

This application claims the benefit of U.S. Provisional Patent Application No. 60/570,369, entitled MIMO System and Mode Table, filed May 11, 2004, the disclosure of which is incorporated by reference herein.

### BACKGROUND

The present invention relates generally to communication systems, and more particularly to wireless communication systems.

A wireless local area network (WLAN) generally includes an access point and a plurality of terminals, with the access point sometimes also referred to as a terminal. The access point and any particular terminal generally communicate using defined protocols over a communication channel occupying a particular frequency spectrum.

Some proposed protocols address the use of multiple input/multiple output (MIMO) wireless devices. In such schemes a single device, whether access point or terminal, may have one or more antennas used for transmission and one or more antennas used for reception, or some combination thereof. MIMO devices may allow for increased communication bandwidth between the devices. However, issues arise as to how the devices may communicate the available number of antennas, how those antennas should be allocated, and what coding schemes should be used for data communication.

### BRIEF SUMMARY OF THE INVENTION

The invention provides MIMO systems and methods.

In one aspect the invention provides a method of determining communication modes between wireless terminals using multiple transmit and/or receive antennas, comprising determining a number of transmit antennas for a first terminal; determining a number of receive antennas for a second terminal; determining a channel quality measure for communications between the first terminal and the second terminal; and selecting a communication mode based on the number of transmit antennas, the number of receive antennas, and the channel quality measure.

In another aspect the invention provides a method relating to communicating between wireless terminals using multiple transmit and/or receive antennas, comprising determining a number of transmit antennas for a first terminal; determining a number of receive antennas for a second terminal; and selecting a communication mode based on the number of transmit antennas and the number of receive antennas; wherein the communication mode varies use of transmit antennas.

In another aspect the invention provides a transmitter in a wireless communication system, comprising circuitry for communicating in a wireless network; multiple antennas for transmitting in the wireless network; a mode processing block for determining a multiple input multiple output (MIMO) mode indicating usage of the multiple antennas.

In another aspect the invention provides a method performed by an element in a wireless communication system, comprising transmitting an initial data packet; receiving an acknowledgement data packet in response to the initial data packet, the acknowledgement data packet including an indication of a number of antennas for a first use; determining a multiple input multiple output mode based on the number of antennas for the first use and a number of antennas for a second use, the first use being for one of receiving or transmitting and the second use being for the other of receiving or transmitting.

One aspect of the invention provides for exchange of information of the number of transmit and receive antennas between two wireless terminals. In some aspects this is accomplished using a dedicated field in a packet header. Another aspect of the invention provides for selection of a mode from a set of allowed modes based on the number of transmit and receive antennas and an estimated channel quality measure. In some aspects the mode specifies how multiple antennas of the transmitter and receiver are used. In further aspects the mode specifies both how multiple antennas of the transmitter and receiver are used and a code used in transmission and reception of information by those antennas. In some aspects the selected mode is a space time block code (STBC) mode or a spatial multiplex (SMX) code mode. In some aspects the mode is communicated from the transmitter to the receiver, and in some aspects this is accomplished using a field in a packet header.

In some aspects the selected mode specifies an Alamouti space time block (AL) code, an AL maximum ratio combining (AL/MRC) code, a circular AL (CIRCAL) code, or a CIRCAL/MRC code. In some aspects the selected mode specifies an MRC code, a SMX code, or a CIRCSMX code.

In some aspects of the invention communication is performed using a circular code. In some aspects of the invention communication is performed between a first node having N_{T} transmit antennas and a second node having N_{R} receive antennas, the first node utilizing different antennas to transmit different symbols, with the number of antennas used at a given time less than N_{T}. In some aspects of the invention the transmitter utilizes N_{T} transmit antennas to communicate information to a receiver, the N_{T} transmit antennas transmitting a diversity code, at least one of the N_{T} transmit antennas not being used for communication of the information to the receiver, with the at least one of the N_{T} transmit antennas varying over time. In some aspects of the invention use of transmitter antennas cycles through transmission of symbols using a diversity code with use of the transmit antennas varying over a time index. In some aspects of the invention at least one of the transmit antennas is not used, with the at least one of the transmit antennas not used varying over a time index.

In some aspects of the invention a WLAN system communicates using a MIMO orthogonal frequency division multiplexing (OFDM) method. In some aspects of the invention a MIMO-OFDM system communicates with use of multiple transmit antennas varying over subcarriers. In some aspects the subcarriers are each approximate a pre-identified frequency and include a plurality of spatial subchannels. In some aspects antenna usage, or non-usage, varies with respect to subcarriers, and in some aspects antenna usage, or non-usage, varies with respect to a subcarrier index. In further aspects antenna usage, or non-usage, varies both with respect to a time index and a subcarrier index.

In some aspects of the invention a communication mode and/or code is selected based on a pre-computed rate versus signal-to-noise ratio (SNR). In some aspects the communication mode or code is also selected based on the number of transmit antennas of a receiver and the number of receive antennas of a receiver.

### BRIEF DESCRIPTION OF THE FIGURES

FIG. 1 illustrates a wireless network in accordance with aspects of the invention;

FIG. 2 is a flow chart of a process in accordance with aspects of the invention;

FIG. 3 is a further flow chart of a process in accordance with aspects of the invention;

FIG. 4 is a further flow chart of a process in accordance with aspects of the invention;

FIG. 5 illustrates a MIMO mode table in accordance with aspects of the invention;

FIG. 6 illustrates a SNR v. rate table in graphical form;

FIG. 7 illustrates a further MIMO mode table in accordance with aspects of the invention; and

FIG. 8 is a heirarchical decomposition of a MIMO-OFDM communication channel.

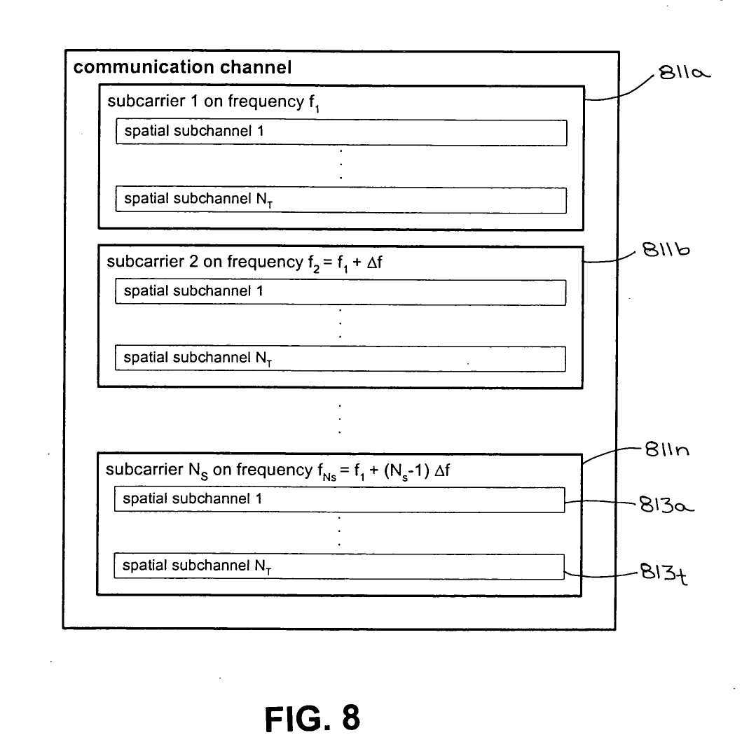

### DETAILED DESCRIPTION

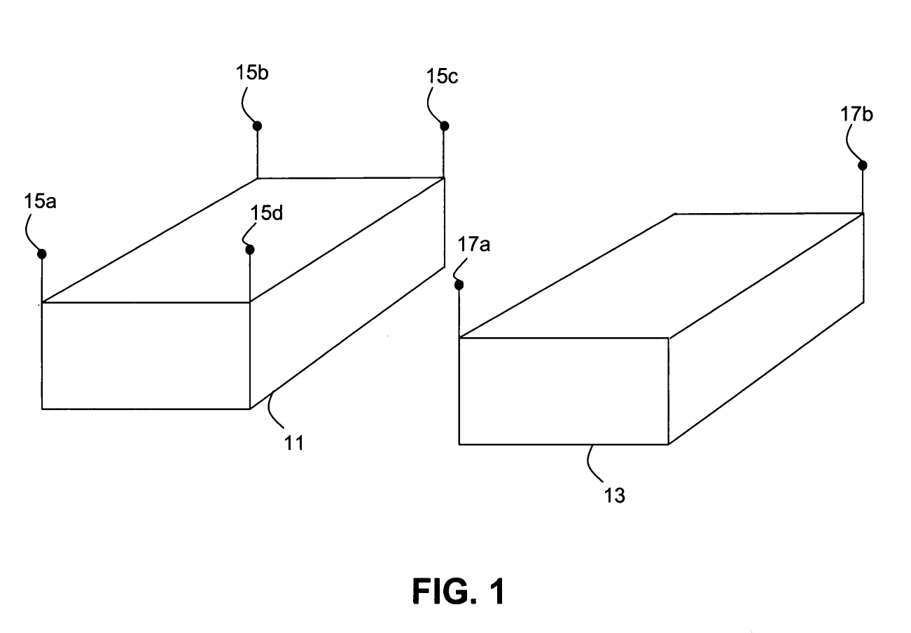

FIG. 1 illustrates a two element wireless local area network operating in accordance with aspects of the invention. It should be recognized, however, that in many instances the wireless local area network may include many more elements than the two elements illustrated in FIG. 1.

As illustrated in FIG. 1, the wireless local area network includes a first element 11 and a second element 13. For primarily discussion purposes, the first element may be considered an access point. The first element includes four antennas 15a-d. The second element includes two antennas 17a-b. In other embodiments, the second element may have more or less than two antennas, and in many embodiments the second element may have four antennas.

More generally, the first element may be viewed as element j, with element j having N_{Tj} transmit antennas and N_{Rj} receive antennas. Similarly, the second element may be viewed as element k, with element k having N_{Tk} transmit antennas and N_{Rk} receive antennas. The first element and the second element communicate using some or all of their respective transmit and receive antennas.

In some embodiments the first element and the second element include wireless transmitter and receiver circuitry. The circuitry may include, for example, puncturers and depuncturers, interleavers and de-interleavers, mappers and de-mappers, FFT and iFFT blocks, filters, D/A and A/D converters, mixers and amplifiers, and other circuitry used in wireless transmission devices. Discussion of such circuitry may be found in, for example, U.S. patent application Ser. No. 11/033,460, entitled Feedback Schemes for a MIMO-OFDM System, filed Jan. 10, 2005, the entire disclosure of which is incorporated by reference herein. In many embodiments the first element and the second element also include mode processing blocks, either as a separate processor or as a circuitry block. In some of these embodiments the mode processing block or blocks determine a MIMO mode for communication between the first terminal and the second terminal, and may also determine a code for such communication. The MIMO mode indicates how antennas of a transmitter are used for transmission of information to a receiver, and how antennas of a receiver are used for reception of information from the transmitter.

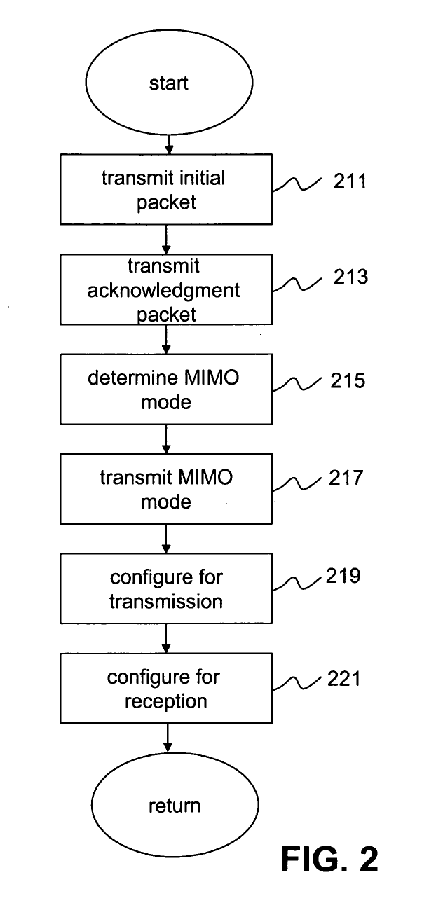

As illustrated in FIG. 2, in block 211 a first element transmits an initial packet to a receiver. The first element may be an access point and may be termed a transmitter. In some embodiments, transmission by the transmitter of the initial packet to the receiver assumes that the receiver has one receive antenna. In block 213 the second element acknowledges receipt of the initial packet by transmitting an acknowledgement packet to the first element. The second element also communicates an indication of the number of its receive antennas and in some embodiments, the number of its transmit antennas, to the first element. In some embodiments the indication is in a preamble portion of the acknowledgement packet. The first element, the transmitter in many embodiments, therefore has information both as to its own number of transmit antennas and receive antennas, and the number of transmit antennas and receive antennas of the receiver.

In block 215 the first element determines use of the antennas based on the number of its transmit antennas and the number of receive antennas of the second element. In some embodiments, the use of the antennas may be considered a mode, or a MIMO mode, specifying the number of antennas used for transmission by a transmitter and the number of antennas used for reception by a receiver, and, in some embodiments, a code for data transmitted or received by an antenna or group of antennas. The transmitter selects the appropriate MIMO mode based on the number of transmit antennas of the transmitter, the number of receive antennas of the receiver. In addition, in some embodiments a channel quality measure is also used to determine the MIMO mode.

In block 217 the MIMO mode is provided by the transmitter to the receiver in, for example, a dedicated field in a packet header. In block 219 the transmitter configures for communication using the MIMO mode. In block 221 the receiver configures for communication using the MIMO mode.

In some embodiments, the initial transmission by the first element includes a number of receive antennas of the first element. In such embodiments, the second element may transmit the acknowledgement packet making use of the number of receive antennas of the transmitter, with this use being selection of a MIMO mode for transmissions by the second element to the first element.

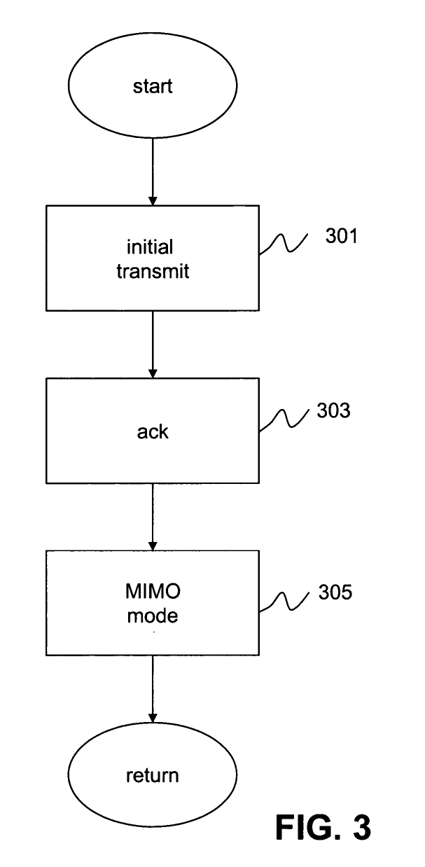

In some embodiments the initial packet exchange, used at least in part to generate a metric regarding the quality of the communication channel(s) between the first element and the second element. For example, FIG. 3 is a flow diagram of a process for generating a metric regarding a quality of a communication channel. In block 311 a first element provides a signal containing information to a second element. The information may be a sequence of symbols part of the initial packet. In block 313 the second element returns a signal containing the received information to the first element. The information may be part of the acknowledgement packet. In block 315 the first element compares information of the transmitted and received signal to determine a characteristic, such as signal-to-noise ratio or bit error rate, indicative of channel quality. Alternatively, the second element may transmit a predefined signal to the first element, which the first element may similarly use to determine a characteristic of channel quality.

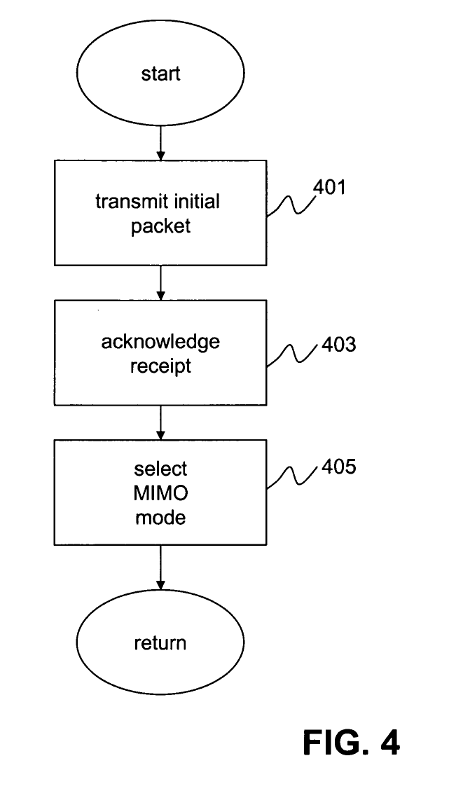

FIG. 4 illustrates an alternative communication process between terminals in a WLAN environment in accordance with aspects of the invention. In block 401 a transmitter transmits initial information to a receiver. The information may be in the form of a packet, and may include preamble fields and data fields. In some embodiments the initial information includes the number of receive antenna of the transmitter. In block 403 the receiver acknowledges receipt of the information by transmitting acknowledgement information. The acknowledgement information includes the number of receive antennas of the receiver, and in some embodiments also includes the number of transmit antennas of the receiver. Also in some embodiments, the receiver selects a MIMO mode based on the number of receive antennas of the transmitter indicated in the initial information, and in some embodiments a channel quality measure determined by the receiver based on the initial information.

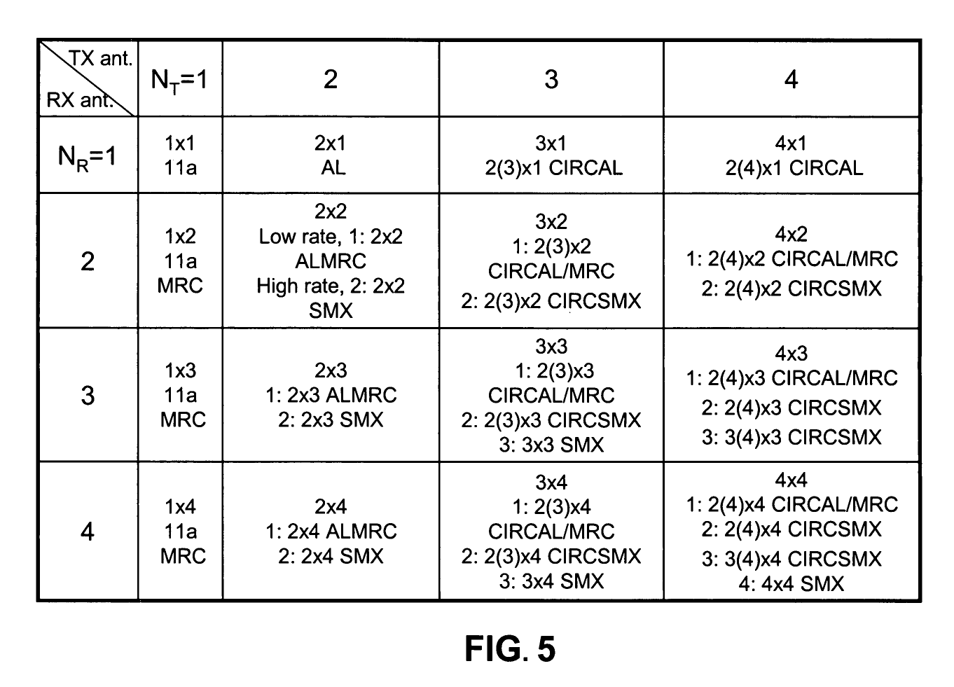

In block 405 the transmitter receives the acknowledgement information and selects a MIMO mode for transmissions to the receiver. The MIMO mode is based on the number of transmitter transmit antennas, the number of receiver receive antennas, and in some embodiment a channel quality measure determined by the transmitter. In some embodiments the MIMO mode is selected from a set of allowed modes, such as provided in FIG. 5.

FIG. 5 indicates a number of modes including an Alamouti space time block code mode (AL), a circular Alamouti space time block code mode (CIRCAL), an Alamouti space time block code mode with maximum ratio combining (ALMRC), a circular Alamouti space time block code mode with maximum ratio combining (CIRCAL/MRC), a spatial multiplex mode (SMX), a circular spatial multiplex mode (CIRCSMX) and variations of the foregoing. The circular modes, for example, are further discussed further below.

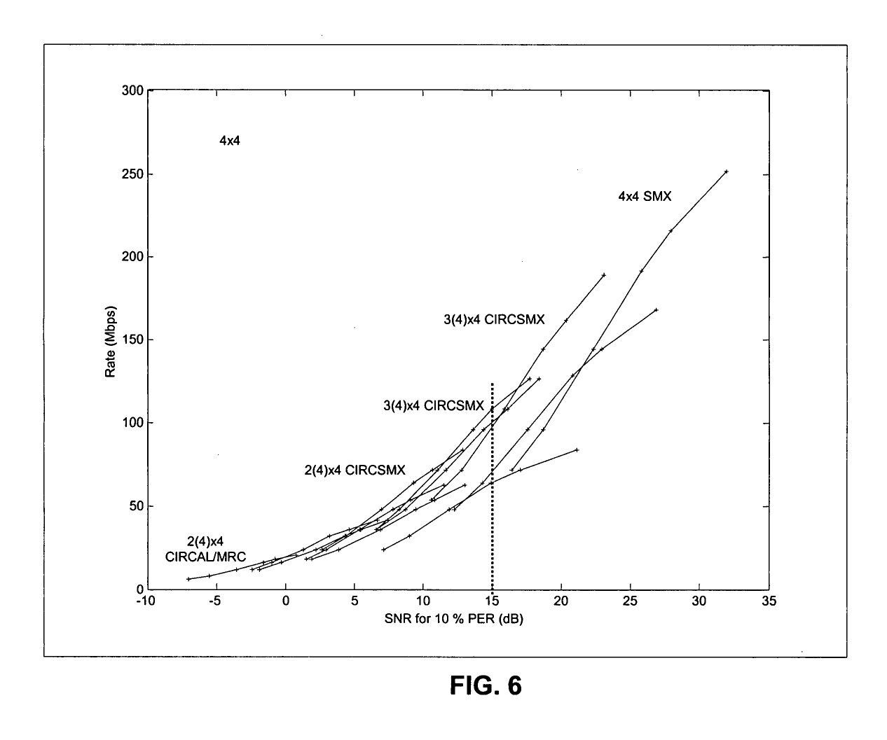

As illustrated in FIG. 5, if there is one transmit antenna then communications are in accordance with 802.11a. If more than one receive antenna is available, then the receiver uses maximum ratio combining (MRC). In some instances, multiple modes are available. For example, if both four transmission antennas and four receiving antennas are available, the mode may be any of 2(4)×4 CIRCAL/MRC, 2(4)×4 CIRCSMX, 3(4)×4 CIRCSMX, or 4×4 SMX. In such instances a particular mode may be selected using a precomputed rate versus signal-to-noise ratio chart. FIG. 6 illustrates a sample precomputed rate versus signal-to-noise ratio chart in graphical form. The chart shows signal-to-noise ratio for different rates for different modes available with four transmission antennas and four receive antennas. In operation, the mode with the highest rate is selected for a particular signal-to-noise to ratio. Thus, for example, if the signal-to-noise ratio 10% PER (dB) is 15, then 3(4)×4 CIRCSMX is selected as the mode.

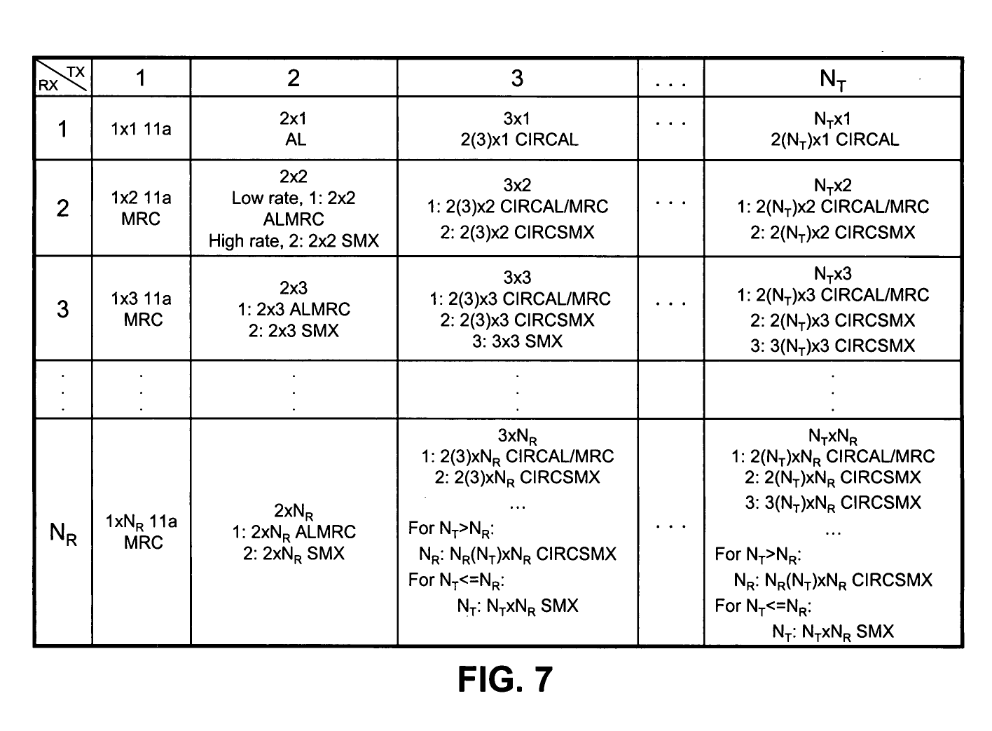

FIG. 7 shows a mode table similar to the mode table of FIG. 5. The mode table and FIG. 7 additionally includes modes for generic situations when the number of transmit antennas is N_{T} and the number of receive antennas is N_{R}. In addition, the mode table of FIG. 7 further differentiates between situations where N_{T}>N_{R} and N_{T}<=N_{R}.

In some embodiments fewer than all of the available transmit antennas are used for transmitting information. However, in some other embodiments, fewer than all of the available transmit antennas are used for a channel symbol, with the non-use of antennas varying in a periodic manner. For example, one MIMO mode may make use of only two transmit antennas simultaneously, even though, for example, three transmit antennas are available. In such an instance, two of the three antennas transmit symbols at a particular time, with the third antenna not transmitting symbols at the particular time.

More concretely, for example, Table I shows a matrix S showing the use of antennas over time for a 2×1 AL mode.

TABLE I
$S = [ \begin{matrix}{s}_{1} & {s}_{2} \\ - {s}_{2}^{*} & {s}_{1}^{*}\end{matrix} ]$

The 2×1 AL mode is for 2 transmit antennas, e.g. N_{Tj}=2, and 1 receive antenna, e.g. N_{Rk}=1. The 2×1 AL mode provides transmit antenna diversity, with a first antenna transmitting symbol s₁, at time t₁, a second antenna transmitting symbol s₂ at time t₁, the first antenna transmitting the negative complex conjugate of symbol s₂, −s₂*, at time t₂, and the second antenna transmitting the complex conjugate of symbol s₁, s₁*, at time t₂. For the 2×1 AL mode, however, all transmit antennas are used simultaneously.

Table II shows an example matrix S for a 2(3)×1 CIRCAL mode.

TABLE II
$S = [ \begin{matrix}{s}_{1} & {s}_{2} & 0 \\ - {s}_{2}^{*} & {s}_{1}^{*} & 0 \\ {s}_{3} & 0 & {s}_{4} \\ - {s}_{4}^{*} & 0 & {s}_{3}^{*} \\ 0 & {s}_{5} & {s}_{6} \\ 0 & - {s}_{6}^{*} & {s}_{5}^{*}\end{matrix} ]$

In the 2(3)×1 CIRCAL mode 2 out of 3 antennas transmit symbols at a time, with the unused antenna varying over time. Similarly, Table III shows an example matrix for a 2(4)×1 CIRCAL mode, in which 2 out of 4 antennas are used to transmit symbols at a time.

TABLE III
$S = [ \begin{matrix}{s}_{1} & {s}_{2} & 0 & 0 \\ - {s}_{2}^{*} & {s}_{1}^{*} & 0 & 0 \\ 0 & 0 & {s}_{3} & {s}_{4} \\ 0 & 0 & - {s}_{4}^{*} & {s}_{3}^{*} \\ {s}_{5} & 0 & {s}_{6} & 0 \\ - {s}_{6}^{*} & 0 & {s}_{5}^{*} & 0 \\ 0 & {s}_{7} & 0 & {s}_{8} \\ 0 & - {s}_{8}^{*} & 0 & {s}_{7}^{*} \\ 0 & {s}_{9} & {s}_{10} & 0 \\ 0 & - {s}_{10}^{*} & {s}_{9}^{*} & 0 \\ {s}_{11} & 0 & 0 & {s}_{12} \\ - {s}_{12}^{*} & 0 & 0 & {s}_{11}^{*}\end{matrix} ]$

In some embodiments antenna usage is cycled during transmission of symbols, such that a first antenna and a second antenna, or any number of antennas in some embodiments, switch effective positions for the various S matrices.

Some embodiments of the invention also make use of the presence of subcarriers in a MIMO-OFDM system. FIG. illustrates an overview of a MIMO-OFDM communication channel. The communication channel, which in some ways may be viewed as a plurality of communication channels, includes a plurality of subcarriers 811a-n. Each of the subcarriers, as illustrated, is at a different frequency. Each subcarrier, in turn, is comprised of a plurality of spatial subchannels. For example, subcarrier Ns includes spatial subchannels 813a-t.

In some embodiments antenna usage is cycled over a subcarrier index. For example, in some embodiments cycling over a CIRCAL or a CIRCSMX mode is performed both over a subcarrier index and a time index. As a more concrete example for a 3×1 CIRCAL code
at time 1, subcarrier 1 uses TX ant 1 and 2
at time 1, subcarrier 2 uses TX ant 1 and 3
at time 1, subcarrier 3 uses TX ant 2 and 3
at time 1, subcarrier 48 uses TX ant 2 and 3
at time 2, subcarrier 1 uses TX ant 1 and 3
at time 2, subcarrier 2 uses TX ant 2 and 3
at time 2, subcarrier 3 uses TX ant 1 and 2
. . .
at time 2, subcarrier 48 uses TX ant 1 and 2 etc.

Accordingly, wireless communication systems and methods are disclosed. Although the invention has been described with respect to certain embodiments, it should be recognized that the invention includes the claims and their equivalents supported by this disclosure.

1. A method of determining communication modes between wireless terminals using multiple transmit and/or receive antennas, comprising:
determining a number of transmit antennas for a first terminal;
determining a number of receive antennas for a second terminal;
determining a channel quality measure for communications between the first terminal and the second terminal; and
selecting a communication mode based on the number of transmit antennas, the number of receive antennas, and the channel quality measure.

2. The method of claim 1 wherein the communication mode indicates use of transmit antennas and receive antennas.

3. The method of claim 1 wherein the communication mode is selected from a set of allowed modes.

4. The method of claim 1 wherein the communication mode is a space time block code mode.

5. The method of claim 1 wherein the communication mode is a spatial multiplex mode.

6. The method of claim 1 wherein the communication mode is a space time block code when the channel quality measure indicates a low channel quality and a spatial multiplex mode when the channel quality measure indicates a high channel quality.

7. The method of claim 1 wherein the first terminal determines the number of transmit antennas for the first terminal, the number of receive antennas for the second terminal, the channel quality measure for communications between the first terminal and the second terminal, and selects the communication mode.

8. The method of claim 7 further comprising receiving an indication of the number of receive antennas for the second terminal by the first terminal.

9. The method of claim 8 wherein the indication of the number of receive antennas for the second terminal is received as part of a field in a packet header.

10. The method of claim 9 further comprising transmitting an indication of the number of transmit antennas for the first terminal to the second terminal.

11. The method of claim 10 wherein the indication of the number of transmit antennas for the first terminal is transmitted as part of a field in a packet header.

12. The method of claim 3 wherein the set of allowed modes includes modes wherein use of transmit antennas varies over time.

13. The method of claim 3 wherein the set of allowed modes includes modes wherein use of transmit antennas varies over subcarriers.

14. The method of claim 3 wherein the set of allowed modes includes modes wherein use of transmit antennas varies over time and varies over subcarriers.

15. The method of claim 3 wherein the set of allowed modes includes at least some of an Alamouti space time block code mode, an Alamouti space time block code with maximum ratio combining, a circular Alamouti space time block code, a spatial multiplex mode, and a circular spatial multiplex mode.

16. A method relating to communicating between wireless terminals using multiple transmit and/or receive antennas, comprising:
determining a number of transmit antennas for a first terminal;
determining a number of receive antennas for a second terminal; and
selecting a communication mode based on the number of transmit antennas and the number of receive antennas;
wherein the communication mode varies use of transmit antennas.

17. The method of claim 16 wherein the number of transmit antennas used varies over time, with the number of transmit antennas being K, the number of transmit antennas used at a given time is K-x, and the antennas comprising transmit antennas K-x varies over time.

18. The method of claim 16 wherein the number of transmit antennas K-x varies over subfrequencies.

19. A transmitter in a wireless communication system, comprising:
circuitry for communicating in a wireless network;
multiple antennas for transmitting in the wireless network;
a mode processing block for determining a multiple input multiple output (MIMO) mode indicating usage of the multiple antennas.

20. The transmitter of claim 19 wherein the mode processing block determines the MIMO mode based on a number of receive antennas of a receiver and the number of multiple antennas for transmitting.

21. The transmitter of claim 20 wherein the mode processing block further determines the MIMO mode based on an indication of channel quality between the receiver and the transmitter.

22. A method performed by an element in a wireless communication system, comprising:
transmitting an initial data packet;
receiving an acknowledgement data packet in response to the initial data packet, the acknowledgement data packet including an indication of a number of antennas for a first use;
determining a multiple input multiple output mode based on the number of antennas for the first use and a number of antennas for a second use, the first use being for one of receiving or transmitting and the second use being for the other of receiving or transmitting.
